(19) United States
(12) Patent Application Publication
(10) Pub. No.: US 2018/0169936 A1
(43) Pub. Date: Jun. 21, 2018

(54) SHAPING DEVICE AND SHAPING METHOD

(71) Applicant: MIMAKI ENGINEERING CO., LTD., Nagano (JP)

(72) Inventor: Kenji HARAYAMA, Nagano (JP)

(21) Appl. No.: 15/844,187

(22) Filed: Dec. 15, 2017

(30) Foreign Application Priority Data
Dec. 20, 2016 (JP) 2016-247152

(51) Int. Cl. B29C 64/112; B29C 64/209; B41J 2/165

(52) U.S. Cl. CPC B29C 64/112; B41J 2/165; B29C 64/209

(57) ABSTRACT

A shaping device includes a shaping time calculating section configured to calculate a time duration required for shaping according to design data; a maintenance managing section configured to store information of a period until when an upcoming maintenance is to be performed; a message output determining section configured to compare a shaping time of a shaping target and the period until the upcoming maintenance when an instruction to start shaping is inputted, and to determine to output a message related to a maintenance when the shaping time is greater than the period until the upcoming maintenance; and a message output section configured to output the message related to the maintenance.

### CROSS REFERENCE TO RELATED APPLICATIONS

This application claims the priority benefit of Japanese Patent Application No. 2016-247152, filed on Dec. 20, 2016. The entirety of the above-mentioned patent application is hereby incorporated by reference herein and made a part of this specification.

### TECHNICAL FIELD

The present disclosure relates to a device and a method for shaping a shaped object.

### DESCRIPTION OF THE BACKGROUND ART

Conventionally, a device that shapes a shaped object using inkjet heads (3D printer) has been known. In such a shaping device, the shaped object is shaped by layering plural ink layers formed by the inkjet heads, for example.

### SUMMARY

A 3D printer needs to have a maintenance performed thereon periodically. However, in a 3D printer as aforementioned, since each shaped object is shaped by layering very thin layers, shaping of one shaped object may take several days in long cases. If such a long-lasting shaping is once started, there were cases where a timing for a periodic maintenance arrives during this shaping.

In such a case, if maintenance work is carried out by pausing the shaping, there is a possibility that this may impose undesirable influence on the finish of the shaped object. For example, streaks may be generated on the shaped object, or color hues may change before and after the maintenance. On the other hand, if the shaping is continued without performing the periodic maintenance, there is a possibility that the shaping will fail.

Thus, in view of the above background, the present disclosure aims to provide a shaping device and a shaping method that minimizes need of a maintenance during shaping.

A shaping device of the present disclosure is a device configured to shape a shaped object, which includes: a shaping time calculating section configured to calculate a time duration required for shaping according to design data; a maintenance managing section configured to store information of a period until when an upcoming maintenance is to be performed; a message output determining section configured to compare a shaping time of a shaping target and the period until the upcoming maintenance when an instruction to start shaping is inputted, and to determine to output a message related to a maintenance when the shaping time is greater than the period until the upcoming maintenance; and an output section configured to output the message related to the maintenance.

According to this configuration, if the time for the upcoming maintenance is to arrive during the shaping, the message notifying such is outputted before starting the shaping, and the occurrence of the maintenance during the shaping can be prevented before happening.

A shaping device of the present disclosure is a device configured to shape a shaped object, which includes: a shaping time calculating section configured to calculate a time required for shaping according to design data; a maintenance managing section configured to store information of an operable time before when an upcoming maintenance is to be performed; a message output determining section configured to compare a shaping time of a shaping target and the operable time before the upcoming maintenance when an instruction to start shaping is inputted, and to determine to output a message related to a maintenance when the shaping time is greater than the period until the upcoming maintenance; and an output section configured to output the message related to the maintenance.

According to this configuration, if the time for the upcoming maintenance is to arrive during the shaping, the message notifying such is outputted before starting the shaping, and the occurrence of the maintenance during the shaping can be prevented before happening.

A shaping device of the present disclosure is a device configured to shape a shaped object, which includes: a shaping time calculating section configured to calculate a time required for shaping according to design data; a message output determining section configured to determine, when an instruction to start shaping is inputted, whether or not to output a message related to a maintenance based on a shaping time of a shaping target; and an output section configured to output the message related to the maintenance.

Since a possibility that the time for a maintenance arrives during the shaping becomes higher in cases where the shaping time is long, a possibility of the occurrence of the maintenance during the shaping can be lowered by giving an alert.

A shaping device of the present disclosure is a device configured to shape a shaped object, which includes: a message output determining section configured to determine, when an instruction to start shaping is inputted, whether or not to output a message related to a maintenance based on a period or an operating time until when an upcoming maintenance is to be performed; and an output section configured to output the message related to the maintenance.

Since the possibility that the time for a maintenance arrives during the shaping becomes higher in cases where the period or the operating time until the upcoming maintenance is short, the possibility of the occurrence of the maintenance during the shaping can be lowered by giving an alert.

In the shaping device of the present disclosure, the output section may be configured to display a screen in which a message notifying that a time for the maintenance is to arrive during the shaping is outputted, and the screen may display a choice for executing the shaping regardless of the message.

According to this configuration, the shaping can be performed even in the case where the time for the maintenance is to arrive during the shaping according to a worker's judgment.

A shaping method of the present disclosure is a method of shaping a shaped object, including: a step of calculating a time duration required for shaping according to design data; a step of reading information of a period until when an upcoming periodic maintenance is to be performed from a periodic maintenance managing section, comparing a shaping time of a shaping target and the period until the upcoming periodic maintenance, and determining to output a message related to a maintenance when the shaping time is greater than the period until the upcoming periodic maintenance, this step being executed when an instruction to start shaping is inputted; a step of outputting the message related to the maintenance when a determination to output the message is made; and a step of performing the shaping when the determination to output the message is not made.

A shaping method of the present disclosure is a method of shaping a shaped object, including: a step of calculating a time duration required for shaping according to design data; a step of reading information of an operable time before when an upcoming periodic maintenance is to be performed from a periodic maintenance managing section, comparing a shaping time of a shaping target and the period until the upcoming periodic maintenance, and determining to output a message related to a maintenance when the shaping time is greater than the period until the upcoming periodic maintenance, this step being executed when an instruction to start shaping is inputted; a step of outputting the message related to the maintenance when a determination to output the message is made; and a step of performing the shaping when the determination to output the message is not made.

A shaping method of the present disclosure is a method of shaping a shaped object, including: a step of calculating a time required for shaping according to design data; a step of determining whether or not to output a message related to a maintenance based on a shaping time of a shaping target, this step being executed when an instruction to start shaping is inputted; a step of outputting the message related to the maintenance when a determination to output the message is made; and a step of performing the shaping when the determination to output the message is not made.

A shaping method of the present disclosure is a method of shaping a shaped object, including: a step of determining whether or not to output a message related to a maintenance based on a period or an operating time until when an upcoming maintenance is to be performed, this step being executed when an instruction to start shaping is inputted; a step of outputting the message related to the maintenance when a determination to output the message is made; and a step of performing the shaping when the determination to output the message is not made.

According to the present disclosure, if the time for the upcoming maintenance is to arrive during the shaping, the message notifying such is outputted before starting the shaping, and the occurrence of the maintenance during the shaping can be prevented before happening.

### BRIEF DESCRIPTION OF THE DRAWINGS

FIG. 1 is a schematic diagram of a shaping device of an embodiment.

FIG. 2 is a perspective diagram illustrating an example of a shaped object.

FIG. 3 is a diagram illustrating details of a flattening roller unit.

FIG. 4 is a diagram illustrating a configuration of a controller.

FIG. 5A is a diagram illustrating an example of a menu displayed on an operation panel before starting shaping. FIG. 5B is a diagram illustrating an example of a message displayed on the operational panel.

FIG. 6 is a flow chart of an operation of the shaping device.

FIG. 7 is a flow chart of an operation of a shaping device of a second embodiment.

FIG. 8A is a diagram illustrating an example of a message displayed on an operation panel. FIG. 8B is a diagram illustrating another example of the message displayed on the operational panel.

FIG. 9 is a flow chart of an operation of a shaping device of a third embodiment.

FIG. 10 is a diagram illustrating an example of data storing an upcoming maintenance date for each maintenance content.

### DETAILED DESCRIPTION OF EMBODIMENTS

Herein below, a shaping device of an embodiment of the present disclosure will be described with reference to the drawings.

### First Embodiment

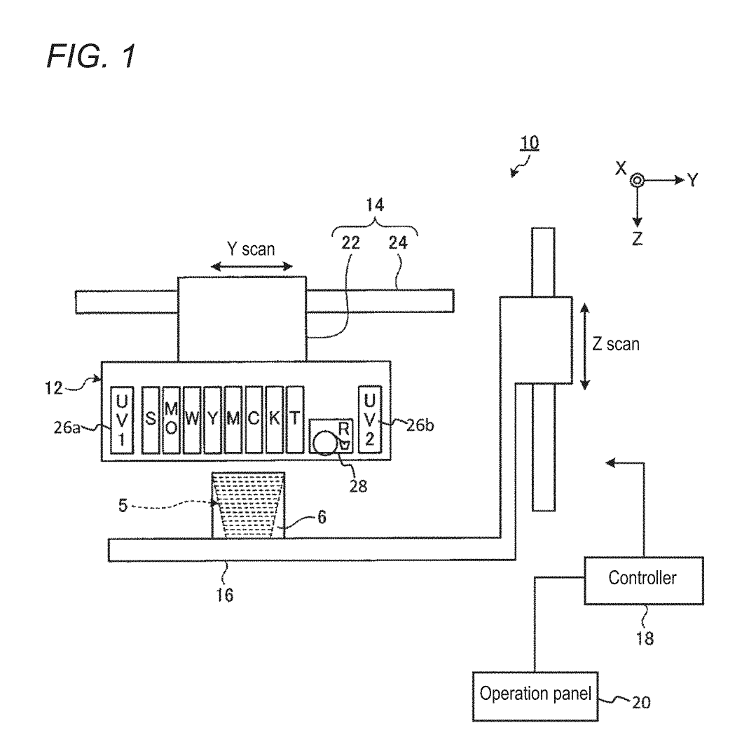

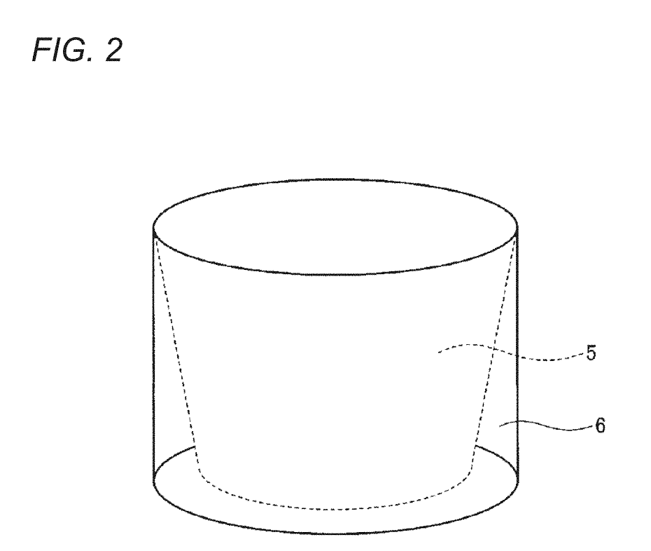

FIG. 1 is a schematic diagram of a shaping device of this embodiment. FIG. 2 is a perspective diagram illustrating an example of a shaped object to be formed by the shaping device illustrated in FIG. 1. The shaping device 10 illustrated in FIG. 1 forms a three-dimensional shaped object 5, for example, by a layered shaping method that performs shaping by layering plural layers.

The shaping device 10 of the present embodiment includes a eject unit 12, a main scanning actuator 14, a shaping stage 16 which is a mounting stage for mounting the shaped object 5, a controller 18, and an operation panel 20. The eject unit 12 is a section that ejects ink to be a material of the shaped object 5. In the present embodiment, ultraviolet curing ink that cures by irradiation of ultraviolet light is used as the material of the shaped object 5.

The eject unit 12 includes a plurality of colored ink heads (Y, M, C, K), a white ink head (W), a transparent ink head (T), a shaping material head (MO), a support material head (S), a plurality of ultraviolet light sources 26a. 26b, and a flattening roller unit 28. The colored ink heads (Y, M, C, K), the white ink head (W), the transparent ink head (T), and the shaping material head (MO) are arranged next to each other along a main scanning direction (Y direction) with their positions in the sub scanning direction (X direction) aligned with each other. It should be noted that, although not shown, the shaping device 10 includes a sub scanning actuator that causes the eject unit 12 to perform a sub scanning operation (X direction) which intersects perpendicular to the main scanning direction (Y direction).

The shaping material head (MO) is an inkjet head for ejecting ink droplets of ultraviolet curing ink used as a shaping material and having fluidity for shaping a shaped object 5. The support material head (S) is an inkjet head for ejecting ink droplets containing a material of a support 6 (see FIG. 2). In a case where the shaped object 5 is to become larger towards its upper portion, a surface to be newly layered atop already-layered surfaces is larger, so a state so-called “overhanging”, in which the ink cannot be layered on the already-layered surfaces, occurs. The support 6 is for supporting the shaped object 5 at portions where such overhanging is occurring. The support 6 can be resolved and removed by water or the like after completion of shaping of the shaped object 5.

The plurality of ultraviolet light sources 26a, 26b are light sources of ultraviolet light for curing the ultraviolet curing ink, and, for example, an ultraviolet LED (Light Emitting Diode), a metal halide lamp, a mercury lamp, or the like can be used. Each of the plurality of ultraviolet light sources 26a, 26b is provided at its corresponding end of the eject unit 12.

The flattening roller unit 28 is a configuration for flattening layers of the ultraviolet curing ink formed during the shaping of the shaped object 5. The flattening roller unit 28 is arranged between the transparent ink head (T) and the ultraviolet light source 26b.

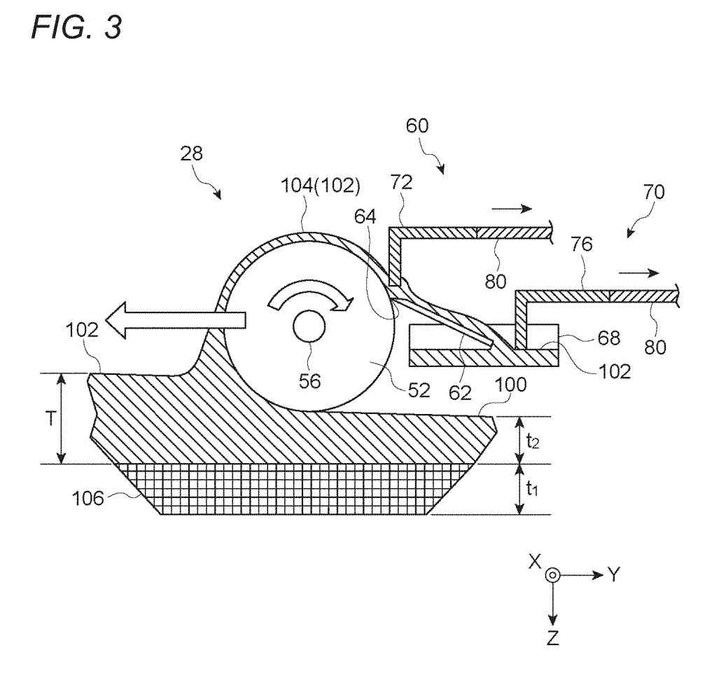

FIG. 3 is a diagram illustrating details of the flattening roller unit 28 illustrated in FIG. 1. The flattening roller unit 28 includes a columnar roller 52 for scraping off an extra shaping material 102, a rotating shaft 56 for rotatably supporting the roller 52, and an extra shaping material collecting mechanism 60 for collecting the extra shaping material 102.

The roller 52 scrapes off the extra shaping material 102, which corresponds to (T-t2) of the shaping material 100 in a flowable state, where a thickness t2 of the flowable shaping material 100 comes to be at a same thickness as a thickness t1 of a cured shaping material 106, which is the shaping material 100 of which curing has been completed by ultraviolet irradiation.

The extra shaping material collecting mechanism 60 includes a blade 62 and a suction device 70. Among them, the blade 62 includes a scraping portion 64 at one end of the blade 62 in the main scanning direction, and scrapes off an adhered material 104 on the roller 52 by the scraping portion 64.

The suction device 70 includes a storage 68 for storing the extra shaping material 102 removed from the roller 52 by the blade 62, a liquid discarding nozzle 76 for sucking the extra shaping material 102 stored in the storage 68, and suction nozzles 72, which is a passage tube for flowing gas or liquid therein. The two suction nozzles 72 are arranged one each near the ends of the blade 62 along the sub scanning direction (X direction), and suck the extra shaping material 102 and air so as to prevent the extra shaping material 102 from flowing out to both sides of the blade 62. The suction nozzles 72 and the liquid discarding nozzle 76 are connected to a fluid passage 80, and the extra shaping material 102 is ejected through the fluid passage 80.

Returning to FIG. 1, a configuration of the shaping device 10 will be described. The main scanning actuator 14 is an actuator for causing the eject unit 12 to perform a main scanning operation. The main scanning operation is an operation to eject the ink droplets while moving in the preset main scanning direction (Y direction in the drawings). The main scanning actuator 14 includes a carriage 22 and a guide rail 24. The guide rail 24 is a rail member for guiding movement of the carriage 22, and moves the carriage 22 according to instructions from the controller 18 during the main scanning operation.

The carriage 22 is a retainer that retains the eject unit 12 by causing it to face the shaping stage 16. That is, the carriage 22 retains the eject unit 12 so that a ejecting direction of the ink droplets ejected from the eject unit 12 comes to be of a direction towards the shaping stage 16.

It should be noted that, the movement of the eject unit 12 during the main scanning operation may be a relative movement with respect to the shaped object 5. Due to this, in a variant of the configuration of the shaping device 10, for example, the position of the eject unit 12 may be fixed and the shaping stage 16 may be moved to move a shaped object 5 side.

The shaping stage 16 is a mounting stage for mounting the shaped object 5 during the shaping on a top surface thereof. This shaping stage 16 has a function to move the top surface in an up and down direction (Z direction in the drawings), and moves the top surface according to instructions from the controller 18 according to progression of the shaping of the shaped object 5. Due to this, a distance (gap) between a shaped surface of the shaped object 5 that is being shaped and the eject unit 12 is suitably adjusted. It should be noted that, a scan in the Z direction along which the shaping stage 16 is moved up and down with respect to the eject unit 12 may be performed by moving a eject unit 12 side in the Z direction.

The controller 18 is a device configured to control respective parts of the shaping device 10, and includes a CPU (Central Processing Unit) that functions as a controller for executing various processes, a RAM (Random Access Memory) and a ROM (Read Only Memory) that function as a memory for storing various types of information, and the like. The controller 18 controls the respective parts of the shaping device 10 according to profile information, color image information, and the like of the shaped object 5 to be shaped to control operations for shaping the shaped object 5.

The operation panel 20 is for providing a user interface for a worker, and has functions to display a state of the shaping device 10, to accept inputs of instructions from the worker, and the like.

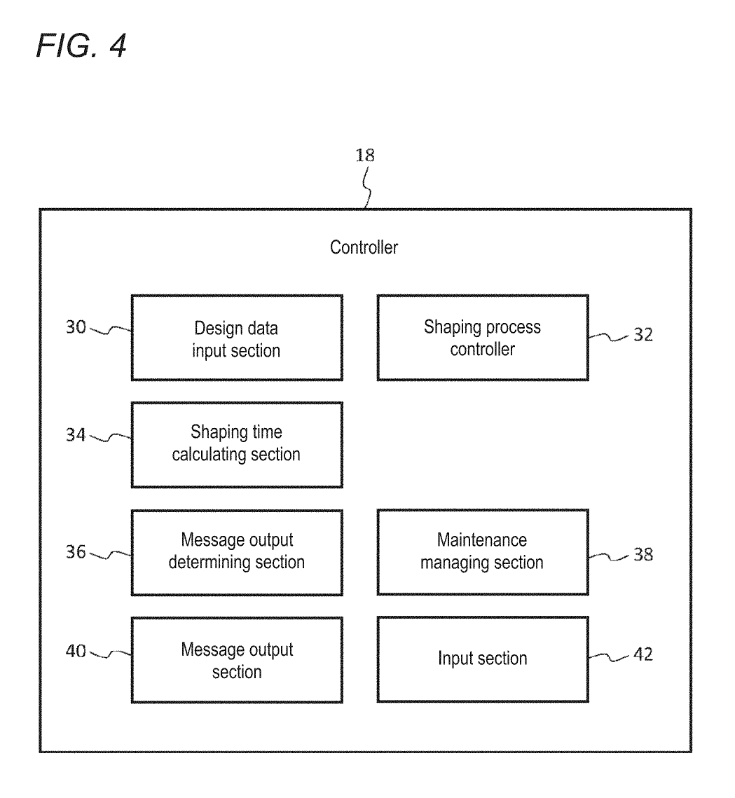

FIG. 4 is a diagram illustrating a configuration of the controller 18. The configuration of the controller 18 will be described in detail with reference to FIG. 4. The controller 18 includes a design data input section 30 and a shaping process controller 32. The design data input section 30 input design data that defines which ink is to be arranged where in each layer configuring the shaped object 5. The shaping process controller 32 has a function to control the eject unit 12, the main scanning actuator 14, the shaping stage 16, and the like according to this design data to perform the shaping.

The controller 18 of the present embodiment includes a shaping time calculating section 34, a message output determining section 36, a maintenance managing section 38, a message output section 40, and an input section 42. According to these configurations, a determination is made on whether or not a time for a periodic maintenance is to arrive during the shaping, and if the time for the periodic maintenance is to arrive during the shaping, such is notified to the worker.

The shaping time calculating section 34 has a function to calculate a time Ta required for performing shaping of a target object according to the design data inputted from the design data input section 30. The time required for shaping the shaped object can be calculated by calculating pixel numbers required for shaping the shaped object from the design data. It should be noted that, the shaping of the shaped object may be one hour even for a short period project, and may take even several days or a week in a long period project.

The message output determining section 36 has a function to determine whether or not the time for the periodic maintenance is to arrive during the shaping of the targeted shaped object. The message output determining section 36 is connected to the maintenance managing section 38 that stores information on the time of an upcoming periodic maintenance. The message output determining section 36 reads data of the time for the upcoming periodic maintenance from the maintenance managing section 38, and calculates a time Tb until the upcoming periodic maintenance. The message output determining section 36 compares the required time duration Ta calculated by the shaping time calculating section 34 and the time Tb until the periodic maintenance. As a result of this, in a case of Ta≤Tb, the message output determining section 36 determines that the time for the periodic maintenance will not arrive during the shaping, and in a case of Ta>Tb, it determines that the time for the periodic maintenance is to arrive during the shaping.

Here, the periodic maintenance is a maintenance performed by the shaping device 10 for suitably shaping shaped objects. A specific example thereof may be that, the storage 68 of the aforementioned extra shaping material collecting mechanism 60 contains the extras of the shaping material 102 as well as scraps that were scraped by the flattening roller 28. The scraps are not ejected through the liquid discarding nozzle 76 and gradually pile up within the storage 68, so a maintenance to clean out the scraps needs to be performed periodically. If this maintenance is not performed, the scraps will overflow from the storage 68, and there is a possibility that the scrapes drop on the layers that are being shaped and deteriorate the finish of the shaped object. In the present embodiment, the periodic maintenance is performed in a certain period cycle (such as every two weeks). Here, an example of the periodic maintenance is given, however, contents of periodic maintenances are not limited to this, and there may be other variations.

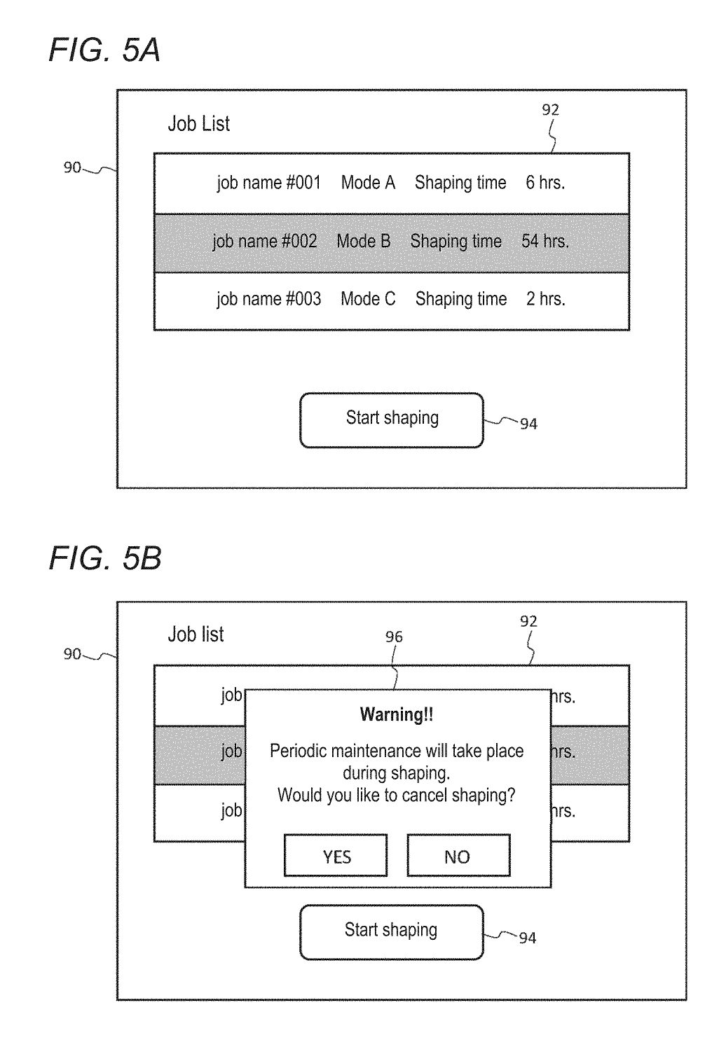

The message output section 40 has a function to display a message indicating that the time for the upcoming periodic maintenance is to arrive during the shaping on the operation panel 20. The message may be termed an alert, depending on its content. FIG. 5A illustrates an example of a menu displayed on the operation panel 20 before starting the shaping, and FIG. 5B illustrates an example of the message displayed on the operation panel 20.

As shown in FIG. 5A, the operation panel 20 before starting the shaping displays information 92 of a plurality of executable jobs and their time durations. This screen 90 is at the same time a display screen and an input screen, and one job among the plurality of jobs can be selected, and shaping of the selected job can be started by pressing a shaping start button 94. In the example illustrated in FIG. 5A, the job “job name #002” is selected, and thus is displayed in inverted contrast. In this state, when the shaping start button 94 is pressed, the job “job name #002” is executed.

The time duration of the job “job name #002” is 54 hours. In a case where the upcoming periodic maintenance read from the maintenance managing section 38 is for example within two days, the time for the periodic maintenance is to arrive during when the job “job name #002” is being executed. In this case, as illustrated in FIG. 5B, a message 96 for giving an alert “Warning!! Periodic maintenance will take place during shaping. Would you like to stop shaping?” is displayed. This message 96 has “YES” and “NO” buttons prepared together, and the shaping is canceled if “YES” is selected. If “NO” is selected, the shaping is not canceled, and the shaping is started.

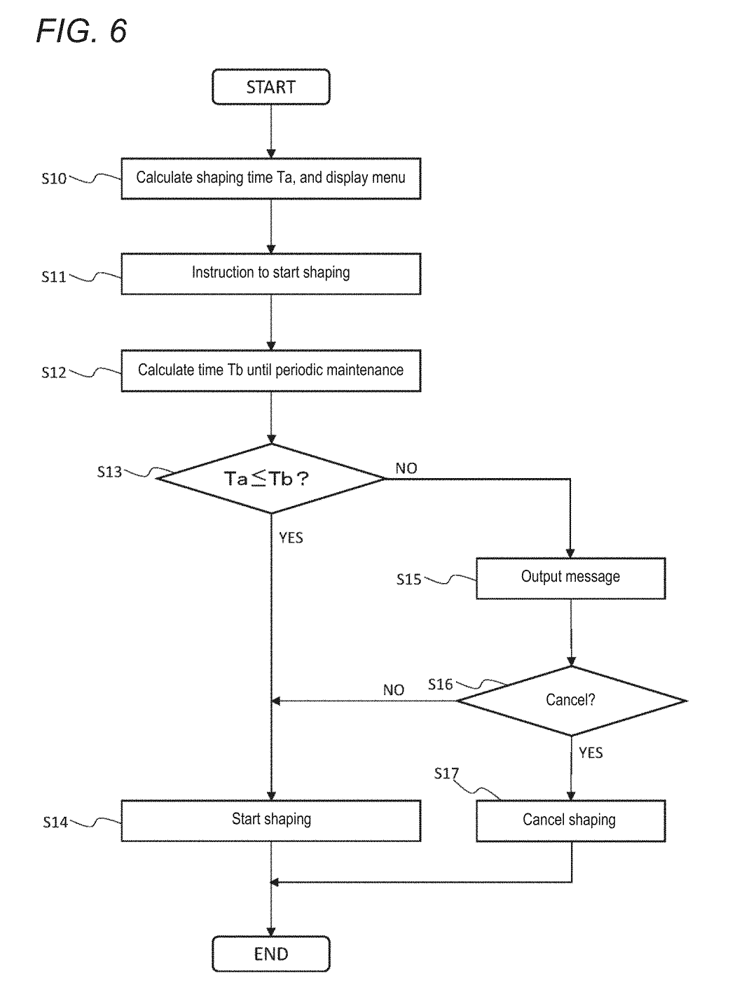

FIG. 6 is a flow chart illustrating an operation of the shaping device 10. When design data of a shaped object 5 is inputted, the shaping device 10 calculates the time Ta required for the shaping of this shaped object 5, and displays information for identifying an executable job and the shaping time Ta on the operation panel 20 (S10). If there are a plurality of executable jobs, the plurality of jobs are displayed as choices as illustrated in FIG. 5A.

When the worker selects a job from the screen of the job list (FIG. 5A) displayed on the operation panel 20 and inputs an instruction to start shaping (S11), the message output determining section 36 of the shaping device 10 reads the information related to the time of the upcoming maintenance from the maintenance managing section 38, and calculates the time Tb until the upcoming periodic maintenance based on a difference from the current time (S12).

Next, the message output determining section 36 compares the shaping time Ta and the time Tb until the upcoming periodic maintenance (S13). As a result, if the shaping time Ta≤Tb until the upcoming periodic maintenance stands true (YES to S13), the shaping is started (S14). If the shaping time Ta≤Tb until the upcoming periodic maintenance does not stand true (NO to S13), the message output section 40 sends an instruction to the operation panel 20 to output a message, and the shaping device 10 outputs the message indicating that the upcoming periodic maintenance is to take place during the shaping, as illustrated in FIG. 5B (S15).

The display screen of this message displays the buttons for selecting whether or not to cancel the work. If the worker selects YES in response to the inquiry to cancel the work, the shaping device 10 cancels the shaping work without starting it (S17). If the worker selects NO in response to the inquiry to cancel the work, the shaping device 10 starts the shaping of the selected job (S14). As above, the shaping device 10 and the shaping method of the first embodiment have been described.

### Variant of First Embodiment

In the aforementioned first embodiment, an example was described in which the maintenance managing section 38 stores the information related to the time for the upcoming periodic maintenance, and the message output determining section 36 calculates the time Tb until the upcoming periodic maintenance from the time for the upcoming periodic maintenance, however, the maintenance managing section 38 may store information of an operating time of the shaping device 10 before the upcoming periodic maintenance. Due to this, even for maintenance items in which the maintenance becomes necessary according to the operating time, the maintenance can be avoided from taking place during the shaping.

### Second Embodiment

Next, a shaping device of the second embodiment will be described. Basic configurations of the shaping device of the second embodiment are same as the shaping device 10 of the first embodiment, however, the shaping device of the second embodiment differs regarding a process of output determination by a message output determining section. The shaping device of the second embodiment determines whether or not to output a message based on the shaping time of the shaping target.

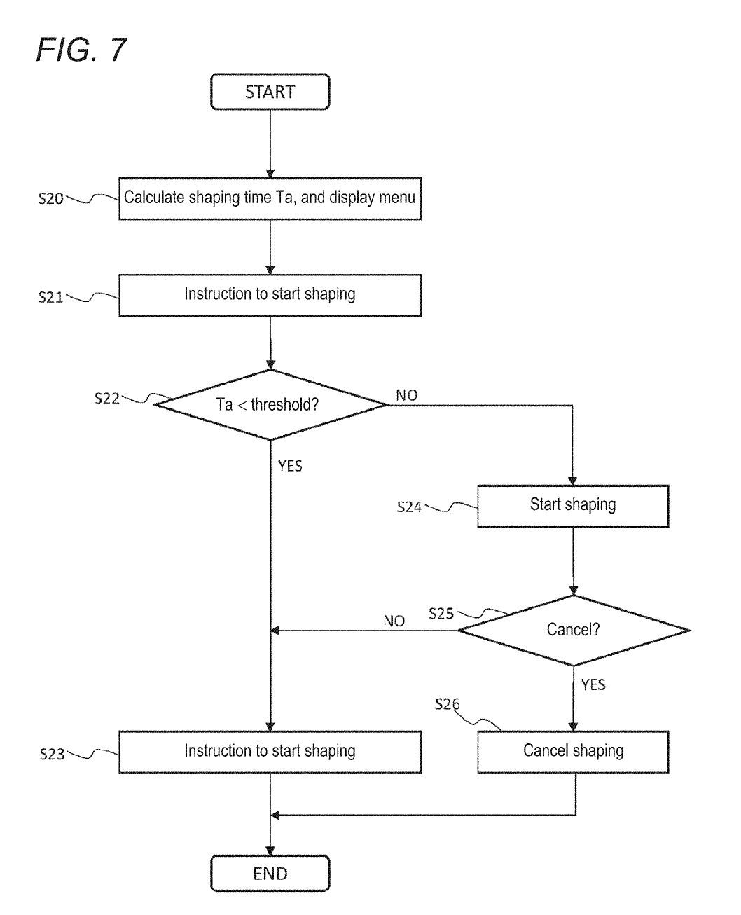

FIG. 7 is a flow chart illustrating an operation of the shaping device of the second embodiment. When design data of a shaped object is inputted, the shaping device calculates a time Ta required for shaping of this shaped object, and displays information for identifying an executable job and the shaping time Ta on an operation panel 20 (S20). If there are a plurality of executable jobs, the plurality of jobs are displayed as choices as illustrated in FIG. 5A.

When a worker selects a job from a screen of a job list (FIG. 5A) displayed on the operation panel 20 and inputs an instruction to start shaping (S21), a message output determining section of the shaping device compares the shaping time Ta and a predetermined threshold (S22). As this threshold, for example, a relatively long time such as 48 hours or 72 hours is set. This is because a possibility of a periodic maintenance interruption during the shaping becomes higher for cases where the shaping time is over a long period of time.

As a result of this determination, if the shaping time Ta<threshold stands true (YES to S22), the shaping is started (S23). If the shaping time Ta<threshold does not stand true (NO to S22), a message output section 40 sends an instruction to output a message to the operation panel 20, and the shaping device outputs the message indicating that an upcoming periodic maintenance is to take place during the shaping (S24).

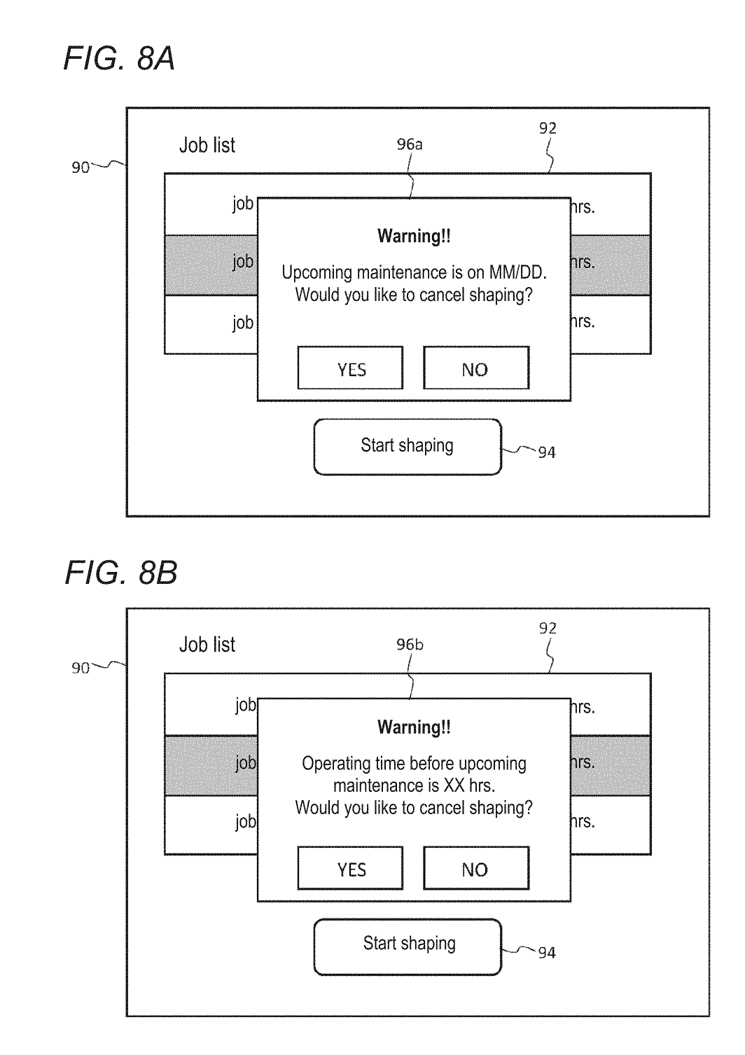

FIG. 8A is a diagram illustrating an example of the message displayed on the operation panel 20. The operation panel 20 displays the message for giving an alert, such as “Warning!! Upcoming maintenance is on MM/DD. Would you like to cancel shaping?” as an example. Data read from a maintenance managing section 38 is used as data of the date of the upcoming maintenance. As above, by outputting the message indicating the date of the upcoming maintenance, the worker can judge whether or not to cancel the shaping (S25). “YES” and “NO” buttons are prepared under this message, and the shaping is canceled if “YES” is selected (S26). If “NO” is selected, the shaping is not canceled, and the shaping is started (S23).

FIG. 8B is a diagram illustrating another example of the message displayed on the operation panel 20. The operation panel 20 displays the message for giving an alert, such as “Warning!! Operating time before upcoming maintenance is XXX hours. Would you like to cancel shaping?” as an example. If the time for the upcoming maintenance is defined by the operating time in the maintenance managing section 38, the worker can be given the alert by a message as above.

### Third Embodiment

Next, a shaping device of the third embodiment will be described. Basic configurations of the shaping device of the third embodiment are same as the shaping device 10 of the first embodiment, however, the shaping device of the third embodiment differs regarding a process of output determination by a message output determining section. The shaping device of the third embodiment determines whether or not to output a message based on the shaping time of the shaping target.

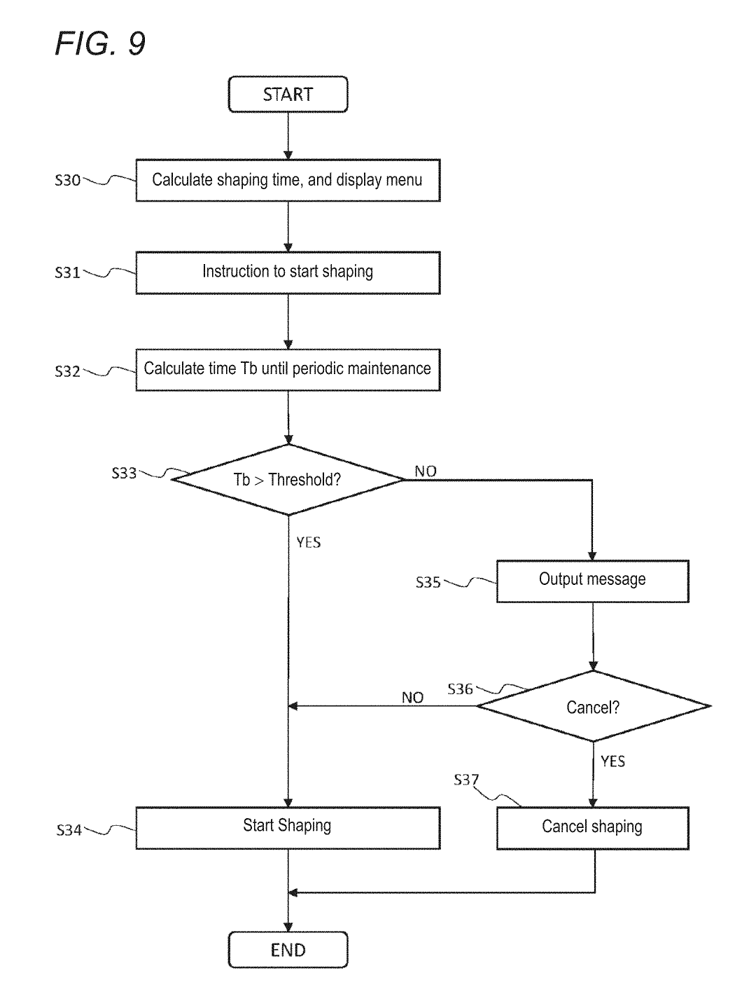

FIG. 9 is a flow chart illustrating an operation of the shaping device of the third embodiment. When design data of a shaped object is inputted, the shaping device calculates a time required for the shaping of this shaped object, and displays information for identifying an executable job and the shaping time on the operation panel 20 (S30). If there are a plurality of executable jobs, the plurality of jobs are displayed as choices as illustrated in FIG. 5A.

When a worker selects a job from the screen of the job list (FIG. 5A) displayed on the operation panel 20 and inputs an instruction to start shaping (S31), a message output determining section 36 of the shaping device reads information related to a time of an upcoming maintenance from a maintenance managing section 38, and calculates a time Tb until the upcoming periodic maintenance based on a difference from the current time (S32).

Next, the message output determining section 36 compares the time Tb until the upcoming periodic maintenance with a predetermined threshold (S33). As this threshold, a time that is shorter than an average shaping time is set, such as 12 hours or 24 hours, for example. This is because a possibility of a periodic maintenance interruption during the shaping becomes higher for cases where the time until the upcoming periodic maintenance is short.

As a result of this determination, if the time Tb until the upcoming periodic maintenance>threshold stands true (YES to S33), the shaping is started (S34). If the time Tb until the upcoming periodic maintenance>threshold does not stand true (NO to S33), a message output section 40 sends an instruction to output a message to the operation panel 20, and the message indicating that an upcoming periodic maintenance is to take place during the shaping is outputted (S35). An example of the message outputted herein is the message illustrated in FIG. 8A or 8B.

The display screen of this message displays the buttons for selecting whether or not to cancel the work. If the worker selects YES in response to the inquiry to cancel the work, the shaping device cancels the shaping work without starting it (S37). If the worker selects NO in response to the inquiry to cancel the work, the shaping device 10 starts the shaping of the selected job (S34).

As above, the shaping devices and shaping methods of the embodiments of the present disclosure were described in detail by giving specific examples, however, the present disclosure is not limited to the aforementioned embodiments. For example, in a case where a periodic maintenance is to be performed independently for each of a plurality of items, it may manage the time for the periodic maintenance for each item.

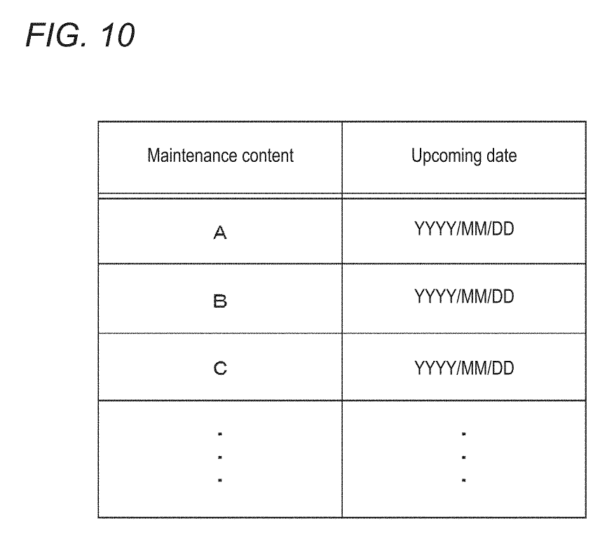

FIG. 10 is a diagram illustrating an example of data storing an upcoming maintenance date for each maintenance content. The maintenance managing section 38 may manage data as illustrated in FIG. 10, and the message output determining section 36 may determine whether or not to output the message by using data of the maintenance date to which the upcoming maintenance date is the closest. In so doing, a content of the upcoming maintenance may be displayed together with information of the period until the upcoming maintenance and the operating time before the upcoming maintenance.

### Effects of Embodiments

(1) The shaping device 10 of the first embodiment includes: the shaping time calculating section 34 configured to calculate a time duration required for shaping according to design data; the maintenance managing section 38 configured to store information of a period until when an upcoming maintenance is to be performed; the message output determining section 36 configured to compare a shaping time Ta of a shaping target and the time Tb until the upcoming maintenance when an instruction to start shaping is inputted, and to determine to output a message related to a maintenance when the shaping time Ta is greater than the time Tb until the upcoming maintenance; and the message output section 40 configured to output the message related to the maintenance. When the message output determining section 36 did not determine to output the message, the shaping device 10 starts the shaping.

Further, the shaping method of the first embodiment is a method of shaping a shaped object, including: a step of calculating a time duration required for shaping according to design data (S10); a step of reading information of a period until when an upcoming periodic maintenance is to be performed from the periodic maintenance managing section 38, comparing a shaping time of a shaping target and the period until the upcoming periodic maintenance, and determining to output a message related to a maintenance when the shaping time Ta is greater than the period Tb until the upcoming periodic maintenance (S13), this step being executed when an instruction to start shaping is inputted (S11); a step of outputting the message related to the maintenance (S15) when a determination to output the message is made (NO to S13); and a step of performing the shaping (S14) when the determination to output the message is not made.

According to this configuration, when the shaping time Ta is greater than the time Tb until the periodic maintenance, that is, when the determination is made that the time for the upcoming maintenance is to arrive during the shaping (NO to S13), the message 96 (see FIG. 5B) notifying such is outputted before starting the shaping, and the occurrence of the maintenance during the shaping can be prevented before happening.

(2) The shaping device of the variant of the first embodiment includes: the shaping time calculating section 34 configured to calculate a time duration required for shaping according to design data; the maintenance managing section 38 configured to store information of an operable time before when an upcoming maintenance is to be performed; the message output determining section 36 configured to compare a shaping time Ta of a shaping target and the operable time before the upcoming maintenance when an instruction to start shaping is inputted, and to determine to output a message 96 related to a maintenance when the shaping time Ta is greater than the time until the upcoming maintenance; and the message output section 40 configured to output the message related to the maintenance.

Further, a shaping method of the variant of the first embodiment is a method of shaping a shaped object, including: a step of calculating a time duration required for shaping according to design data; a step of reading information of an operable time before when an upcoming periodic maintenance is to be performed from the periodic maintenance managing section 38, comparing a shaping time of a shaping target and the period until the upcoming periodic maintenance, and determining to output a message related to a maintenance when the shaping time is greater than the period until the upcoming periodic maintenance, this step being executed when an instruction to start shaping is inputted; a step of outputting the message related to the maintenance when a determination to output the message is made; and a step of performing the shaping when the determination to output the message is not made.

According to this configuration, if the time for the upcoming maintenance is to arrive during the shaping, the message 96 (see FIG. 5B) notifying such is outputted before starting the shaping, and the occurrence of the maintenance during the shaping can be prevented before happening.

(3) A shaping device of the second embodiment is a device configured to shape a shaped object, which includes: a shaping time calculating section configured to calculate a time required for shaping according to design data; a message output determining section configured to determine, when an instruction to start shaping is inputted, whether or not to output a message related to a maintenance based on a shaping time of a shaping target; and a message output section configured to output the message related to the maintenance.

Further, a shaping method of the second embodiment is a method of shaping a shaped object, including: a step of calculating a time required for shaping according to design data (S20); a step of determining whether or not to output a message related to a maintenance based on a shaping time of a shaping target (S22), this step being executed when an instruction to start shaping is inputted (S21); a step of outputting the message related to the maintenance (S24) when a determination to output the message is made: and a step of performing the shaping (S23) when the determination to output the message is not made.

Since the possibility that the time for a maintenance arrives during the shaping becomes higher in cases where the shaping time of the shaping target is long, when the shaping time Ta is greater than the predetermined threshold, the possibility of the occurrence of the maintenance during the shaping can be lowered by giving an alert.

(4) A shaping device of the third embodiment is a device configured to shape a shaped object, which includes: a message output determining section configured to determine, when an instruction to start shaping is inputted, whether or not to output a message related to a maintenance based on a period or an operating time until when an upcoming maintenance is to be performed; and a message output section configured to output the message related to the maintenance.

Further, a shaping method of the third embodiment is a method of shaping a shaped object, including: a step of determining whether or not to output a message related to a maintenance based on a period or an operating time until when an upcoming maintenance is to be performed (S33), this step being executed when an instruction to start shaping is inputted (S31); a step of outputting the message related to the maintenance (S35) when a determination to output the message is made (NO to S33); and a step of performing the shaping (S34) when the determination to output the message is not made.

Since the possibility that the time for a maintenance arrives during the shaping becomes higher in cases where the period or the operating time until the upcoming maintenance is short, the possibility of the occurrence of the maintenance during the shaping can be lowered by giving an alert.

(5) In the shaping device of the present embodiments, the message output section 40 may be configured to display the screen 90 in which the message 96 notifying that the time for the maintenance is to arrive during the shaping is outputted, and the screen 90 may display a choice for executing the shaping regardless of the message 96.

According to this configuration, the shaping can be performed even in the case where the time for the maintenance is to arrive during the shaping according to a worker's judgment.

### INDUSTRIAL APPLICABILITY

The present disclosure is useful as a 3D printer or the like that shapes a shaped object using inkjet heads.

What is claimed is:

1. A shaping device configured to shape a shaped object, the device comprising:
a shaping time calculating section configured to calculate a time duration required for shaping according to design data;
a maintenance managing section configured to store information of a period until when an upcoming maintenance is to be performed;
a message output determining section configured to compare a shaping time of a shaping target and the period until the upcoming maintenance when an instruction to start shaping is inputted, and to determine to output a message related to a maintenance when the shaping time is greater than the period until the upcoming maintenance; and
an output section configured to output the message related to the maintenance.

2. A shaping device configured to shape a shaped object, the device comprising:
a shaping time calculating section configured to calculate a time required for shaping according to design data;
a maintenance managing section configured to store information of an operable time before when an upcoming maintenance is to be performed;
a message output determining section configured to compare a shaping time of a shaping target and the operable time before the upcoming maintenance when an instruction to start shaping is inputted, and to determine to output a message related to a maintenance when the shaping time is greater than the period until the upcoming maintenance; and
an output section configured to output the message related to the maintenance.

3. A shaping device configured to shape a shaped object, the device comprising:
a shaping time calculating section configured to calculate a time required for shaping according to design data;
a message output determining section configured to determine, when an instruction to start shaping is inputted, whether or not to output a message related to a maintenance based on a shaping time of a shaping target; and
an output section configured to output the message related to the maintenance.

4. A shaping device configured to shape a shaped object, the device comprising:
a message output determining section configured to determine, when an instruction to start shaping is inputted, whether or not to output a message related to a maintenance based on a period or an operating time until when an upcoming maintenance is to be performed; and
an output section configured to output the message related to the maintenance.

5. The shaping device according to claim 1, wherein the output section is configured to display a screen in which a message notifying that a time for the maintenance is to arrive during the shaping is outputted, and
the screen displays a choice for executing the shaping regardless of the message.

6. A shaping method of shaping a shaped object, the method comprising:
a step of calculating a time duration required for shaping according to design data;
a step of reading information of a period until when an upcoming periodic maintenance is to be performed from a periodic maintenance managing section, comparing a shaping time of a shaping target and the period until the upcoming periodic maintenance, and determining to output a message related to a maintenance when the shaping time is greater than the period until the upcoming periodic maintenance, this step being executed when an instruction to start shaping is inputted;
a step of outputting the message related to the maintenance when a determination to output the message is made; and
a step of performing the shaping when the determination to output the message is not made.

7. A shaping method of shaping a shaped object, the method comprising:
a step of calculating a time duration required for shaping according to design data;
a step of reading information of an operable time before when an upcoming periodic maintenance is to be performed from a periodic maintenance managing section, comparing a shaping time of a shaping target and the period until the upcoming periodic maintenance, and determining to output a message related to a maintenance when the shaping time is greater than the period until the upcoming periodic maintenance, this step being executed when an instruction to start shaping is inputted;
a step of outputting the message related to the maintenance when a determination to output the message is made; and
a step of performing the shaping when the determination to output the message is not made.

8. A shaping method of shaping a shaped object, the method comprising:
a step of calculating a time required for shaping according to design data;
a step of determining whether or not to output a message related to a maintenance based on a shaping time of a shaping target, this step being executed when an instruction to start shaping is inputted;
a step of outputting the message related to the maintenance when a determination to output the message is made; and
a step of performing the shaping when the determination to output the message is not made.

9. A shaping method of shaping a shaped object, the method comprising:
a step of determining whether or not to output a message related to a maintenance based on a period or an operating time until when an upcoming maintenance is to be performed, this step being executed when an instruction to start shaping is inputted;
a step of outputting the message related to the maintenance when a determination to output the message is made; and
a step of performing the shaping when the determination to output the message is not made.

10. The shaping device according to claim 2, wherein the output section is configured to display a screen in which a message notifying that a time for the maintenance is to arrive during the shaping is outputted, and
the screen displays a choice for executing the shaping regardless of the message.

11. The shaping device according to claim 3, wherein the output section is configured to display a screen in which a message notifying that a time for the maintenance is to arrive during the shaping is outputted, and
the screen displays a choice for executing the shaping regardless of the message.

12. The shaping device according to claim 4, wherein the output section is configured to display a screen in which a message notifying that a time for the maintenance is to arrive during the shaping is outputted, and
the screen displays a choice for executing the shaping regardless of the message.
